(19) United States
(12) Patent Application Publication
(10) Pub. No.: US 2018/0172512 A1
(43) Pub. Date: Jun. 21, 2018

(54) OPTICAL SPECTRUM MEASUREMENT DEVICE

(71) Applicants: Yokogawa Electric Corporation, Tokyo (JP); YOKOGAWA TEST & MEASUREMENT CORPORATION, Tokyo (JP)

(72) Inventors: Ryo TAMAKI, Tokyo (JP); Manabu KOJIMA, Tokyo (JP); Atsushi HORIGUCHI, Tokyo (JP); Tsutomu KANEKO, Tokyo (JP); Toshikazu YAMAMOTO, Tokyo (JP); Tohru MORI, Tokyo (JP)

(73) Assignees: Yokogawa Electric Corporation, Tokyo (JP); YOKOGAWA TEST & MEASUREMENT CORPORATION, Tokyo (JP)

(21) Appl. No.: 15/819,659

(22) Filed: Nov. 21, 2017

(30) Foreign Application Priority Data
Dec. 19, 2016 (JP) 2016-244990

(51) Int. Cl. G01J 3/18; G01J 3/04; G01J 3/02

(52) U.S. Cl. CPC G01J 3/18; G01J 3/04; G01J 3/453; G01J 3/027; G01J 3/0235

(57) ABSTRACT

An optical spectrum measurement device includes: a grating spectroscope that disperses an incident light, the grating spectroscope emitting the incident light from a slit; a plurality of photodiode sensors that has mutually different light receiving properties; a movable table on which the plurality of photodiode sensors is placed so as to align on a planar surface perpendicular to a traveling direction of an emitted light from the slit; and a driving mechanism that moves the movable table so as to have a state where the emitted light enters into any of the plurality of photodiode sensors.

### CROSS-REFERENCE TO RELATED APPLICATION

This application claims priority from Japanese Patent Application No. 2016-244990 filed with the Japan Patent Office on Dec. 19, 2016, the entire content of which is hereby incorporated by reference.

### BACKGROUND

### 1. Technical Field

This disclosure relates to an optical spectrum measurement device.

### 2. Description of the Related Art

An optical spectrum measurement device performs an analyzation by receiving an input light and measuring optical powers corresponding to respective wavelengths of an incident light by a spectroscopy. The optical spectrum measurement device is widely used for, for example, a measurement whose object is an evaluation of an optical fiber transmission system and a property evaluation of a device for optical communication.

FIG. 8 illustrates a measurement principle of a typical optical spectrum measurement device 500. An input light of a measurement target is divided into narrow wavelength slots with an optical bandpass filter 521, and is transformed into an electrical signal with a photodiode 540. Then, the electrical signal is amplified with an amplifier 550, and is transformed into a digital signal with an AD converter 560.

Plotting a signal obtained by sweeping a center wavelength in the optical bandpass filter 521 can provide an optical spectrum. The optical spectrum is displayed on a display device 570 as a measurement result. This optical bandpass filter 521 is a mechanical device that uses a diffraction grating as a wavelength dispersion element and is referred to as a monocromator. In the optical bandpass filter 521, an angle of the diffraction grating disposed on a rotary stage is changed with a position controller 526 that includes a motor. This sweeps the center wavelength in the optical bandpass filter 521.

A technique in this field is disclosed, for example, in JP-A-2-85729.

### SUMMARY

An optical spectrum measurement device includes: a grating spectroscope that disperses an incident light, the grating spectroscope emitting the incident light from a slit; a plurality of photodiode sensors that has mutually different light receiving properties; a movable table on which the plurality of photodiode sensors is placed so as to align on a planar surface perpendicular to a traveling direction of an emitted light from the slit; and a driving mechanism that moves the movable table so as to have a state where the emitted light enters into any of the plurality of photodiode sensors.

### BRIEF DESCRIPTION OF THE DRAWINGS

FIG. 1 is a block diagram illustrating a basic configuration of an optical spectrum measurement device of an embodiment;

FIG. 2 illustrates a first example of parallel photodiodes;

FIG. 3 is a drawing for describing a movement direction of the parallel photodiodes;

FIG. 4 illustrates a shape of a slit in the first example;

FIGS. 5A and 5B illustrate a state where the parallel photodiodes move;

FIG. 6 illustrates a second example of parallel photodiodes;

FIG. 7 illustrates a shape of a slit in the second example;

FIG. 8 illustrates a measurement principle of a typical optical spectrum measurement device;

FIG. 9 is a drawing for describing a coaxial composite photodiode;

FIG. 10 is a drawing for describing a cause of ripple occurrence; and

FIG. 11 illustrates a measurement result on which the ripple is superimposed.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In an optical spectrum measurement device, a measurement bandwidth is restricted corresponding to properties of a used optical element. For example, a band of a light that can be transmitted through a spectroscope is restricted corresponding to diffraction efficiency of a diffraction grating. When a wavelength of the light transmitted through the spectroscope misses a range of a light sensitivity of a photodiode, transforming the light into an electrical signal becomes difficult. In this case, measuring a light spectrum is difficult. In view of this, an appropriate optical element that corresponds to the measurement bandwidth is chosen.

For example, an InGaAs sensor, which is generally included in a photodiode of an optical spectrum measurement device, has a high sensitivity in a near-infrared region of 800 nm to 1700 nm. However, in a range of a wavelength shorter or a wavelength longer than this, the sensitivity of this sensor rapidly decreases.

In view of this, when a light with a short wavelength is measured, for example, a photodiode (an Si photodiode) including an Si sensor that has an excellent sensitivity in a range of 400 nm to 1100 nm is used. However, the sensitivity of the Si photodiode also rapidly decreases outside this range.

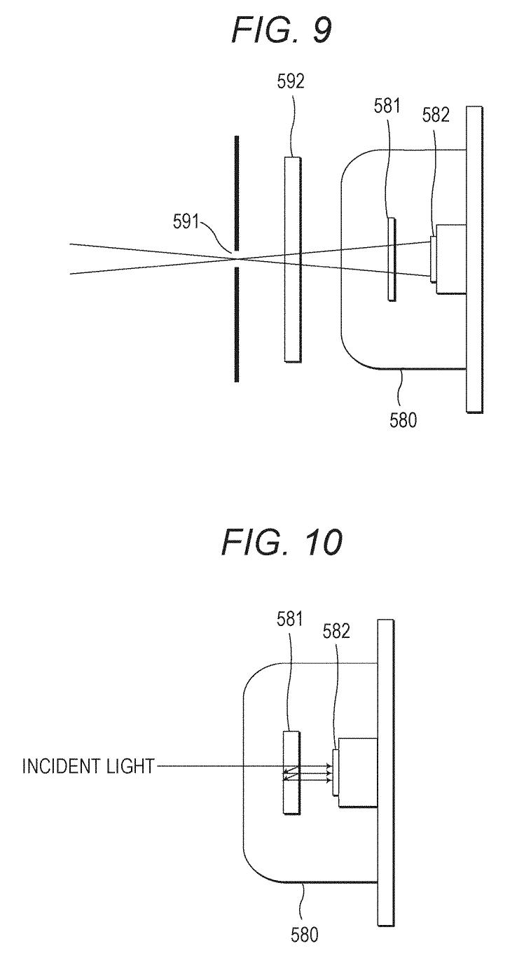

Therefore, in order to achieve a wide measurement bandwidth, using two photodiodes that have different properties by switching the two photodiodes depending on a wavelength range can be considered. For example, in a configuration illustrated in FIG. 9, a commercially available coaxial composite photodiode 580 is used. In this configuration, two sensors (a first sensor 581 and a second sensor 582) that have mutually different sensitivity bands are coaxially arranged in a package of the photodiode. In the configuration illustrated in FIG. 9, a slit 591 and an optical filter 592 are disposed in a front stage of the coaxial composite photodiode 580.

In the coaxial composite photodiode 580, a light that has a wavelength included in a range that the second sensor 582 receives is transmitted through the first sensor 581 and enters into the second sensor 582. In view of this, switching of the sensor used for receiving the light can be electrically performed. This eliminates the necessity of a mechanism for switching, thereby ensuring widening the measurement bandwidth without slowing down a measurement speed.

However, the light measured with the second sensor 582 passing through the first sensor 581 causes some problems.

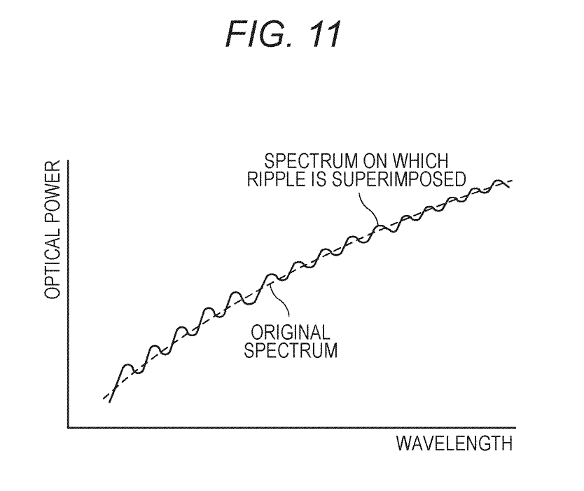

A first problem is that a ripple is superimposed on a measured waveform. That is, the first sensor 581 has a parallel flat plate-shape. In view of this, as illustrated in FIG. 10, a part of an incident light is reflected between end surfaces of the first sensor 581 and an interference occurs. In view of this, as illustrated in FIG. 11, the ripple that corresponds to a thickness of the first sensor 581 is superimposed on a measurement result of an optical spectrum in the second sensor 582. As a result, performing an accurate measurement becomes difficult.

This ripple has a periodic wavelength λ_{FSR} that can be obtained by the following formula (1). Here, λ is a wavelength, n is a refractive index of the first sensor 581, and L is a thickness of the first sensor 581.

$${λ}_{FSR} \approx \frac{{λ}^{2}}{2 nL} \qquad ( 1 )$$

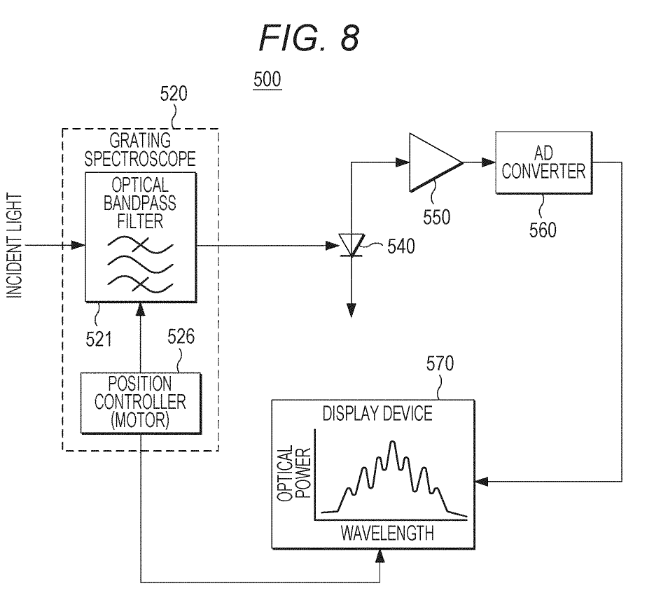

As an example, λ=1530 nm, n=3.48, and L=0.25 mm. In this case, the periodic wavelength λ_{FSR} of the appearing ripple is 1.35 nm. At this time, when a resolution of the measurement device is equal to or wider than the periodic wavelength, this ripple is averaged and becomes indistinctive. That is, the problem regarding the ripple is remarkable when a measurement in a high resolution is performed. In the optical spectrum measurement device 500 as illustrated in FIG. 8, a measurement in a high resolution of 100 pm or less is generally performed. In view of this, the problem regarding the ripple is significant.

A second problem is that measurement efficiency decreases. In the coaxial composite photodiode 580, it is assumed that the sensors are switched at a point where the sensitivities cross. When a wavelength range as a measurement target in the first sensor 581 overlaps a wavelength range as a measurement target in the second sensor 582, a light with a wavelength in this overlapping portion is absorbed by the first sensor 581. As a result, a light that reaches the second sensor 582 decreases. In view of this, the measurement efficiency that relates to a range (the above-described overlapping portion) where the sensitivities cross significantly decreases.

Therefore, an object of this disclosure is to provide an optical spectrum measurement device that has a wide measurement bandwidth while a deterioration of a measurement quality is restrained.

An optical spectrum measurement device according to one aspect of the present disclosure includes: a grating spectroscope that disperses an incident light, the grating spectroscope emitting the incident light from a slit; a plurality of photodiode sensors that has mutually different light receiving properties; a movable table on which the plurality of photodiode sensors is placed so as to align on a planar surface perpendicular to a traveling direction of an emitted light from the slit; and a driving mechanism that moves the movable table so as to have a state where the emitted light enters into any of the plurality of photodiode sensors.

Here, the slit may have a shape that extends in a non-dispersion direction of the emitted light from the grating spectroscope.

Further, the plurality of photodiode sensors may be aligned in a dispersion direction of the emitted light from the grating spectroscope, and the driving mechanism may be configured to move the movable table in the dispersion direction.

Further, the plurality of photodiode sensors may be housed in one package.

According to this disclosure, provided is an optical spectrum measurement device that has a wide measurement bandwidth while a deterioration of a measurement quality is restrained.

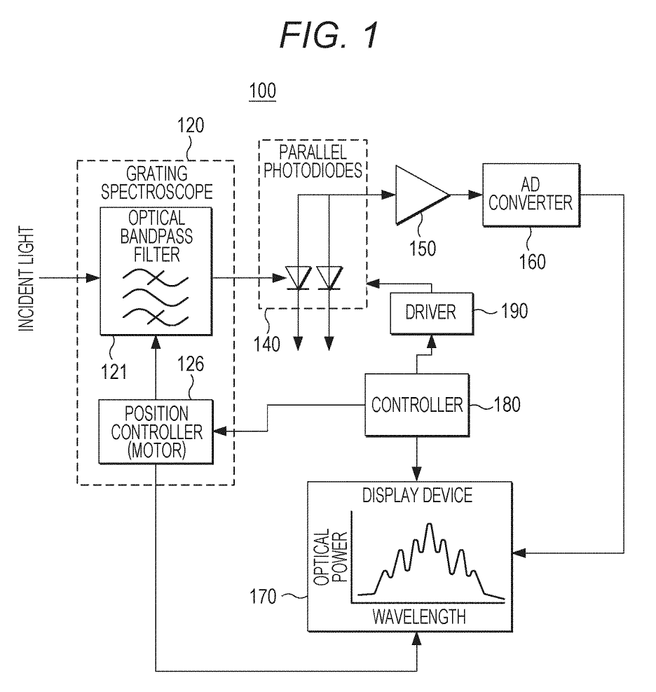

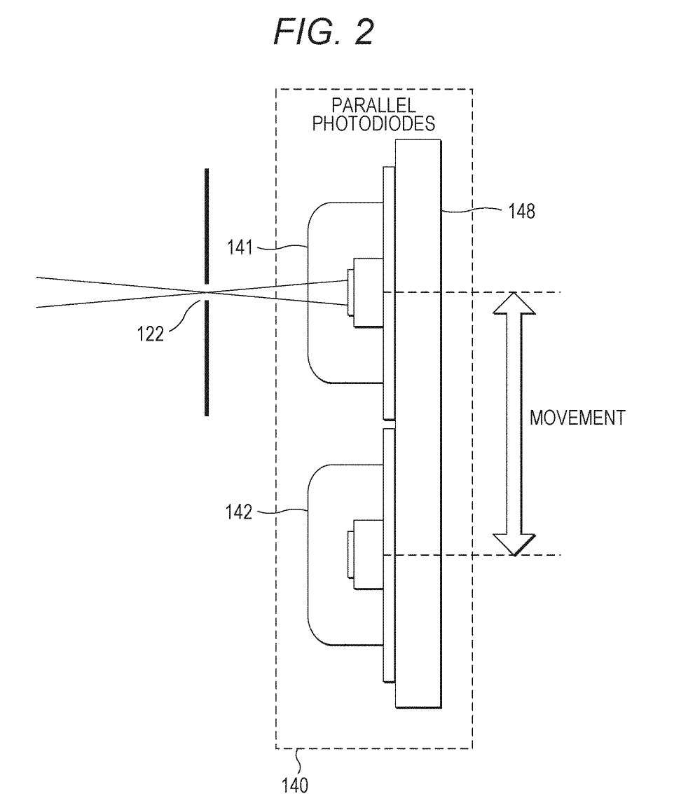

An embodiment of this disclosure will be described with reference to the drawings. FIG. 1 is a block diagram illustrating a basic configuration of an optical spectrum measurement device of the embodiment. As illustrated in FIG. 1, an optical spectrum measurement device 100 includes a grating spectroscope 120, a slit plate (a slit unit) including a slit 122 (see FIG. 2), parallel photodiodes 140, an amplifier 150, an AD converter 160, a display device 170, a controller 180, and a driver 190. The driver 190 (and the controller 180) corresponds to a moving mechanism of this disclosure.

The grating spectroscope 120 includes an optical bandpass filter 121 and a position controller 126. The optical bandpass filter 121 includes a monocromator that uses a diffraction grating as a wavelength dispersion element. The position controller 126 sweeps a center wavelength in the optical bandpass filter 121 by changing an angle of the diffraction grating disposed on a rotary stage using a motor.

An input light of a measurement target is, for example, divided into narrow wavelength slots and caused to enter into the parallel photodiodes 140 via the slit 122 with the optical bandpass filter 121. The parallel photodiodes 140 transform this light into an electrical signal. The amplifier 150 amplifies this electrical signal. The AD converter 160 transforms the amplified electrical signal into a digital signal. Plotting a signal obtained by sweeping the center wavelength in the optical bandpass filter 121 can provide an optical spectrum. The display device 170 displays this optical spectrum as a measurement result.

As illustrated in FIG. 1, the optical spectrum measurement device 100 according to the embodiment includes the parallel photodiodes 140. In the parallel photodiodes 140, a plurality of photodiode sensors is disposed such that photo-receiving surfaces of the respective photodiode sensors are arranged on an identical surface. Note that the “identical” in this description includes not only a completely identical state, but also a state of substantially identical.

FIG. 2 illustrates a first example of the parallel photodiodes 140. In the first example of the parallel photodiodes 140, a first photodiode 141 and a second photodiode 142 that have mutually different measurement bandwidths are placed on a block (movable table) 148. A photo-receiving surface of the first photodiode 141 and a photo-receiving surface of the second photodiode 142 are both aligned on a planar surface perpendicular to a traveling direction of an emitted light from the slit 122. Note that a count of the photodiodes arranged in parallel is not necessarily limited to two, but may be three or more. The “perpendicular” in this description includes not only a completely perpendicular state, but also a state of substantially perpendicular.

This block 148 (the parallel photodiodes 140) is moved by the driver 190. This causes the light that passes through the slit 122 to enter into any of the first photodiode 141 and the second photodiode 142. The driver 190 may be, for example, a stepper motor. A movement direction of the block 148 is an alignment direction of the first photodiode 141 and the second photodiode 142 as illustrated in FIG. 2. The controller 180 controls a movement of the block 148 (the parallel photodiodes 140) by the driver 190.

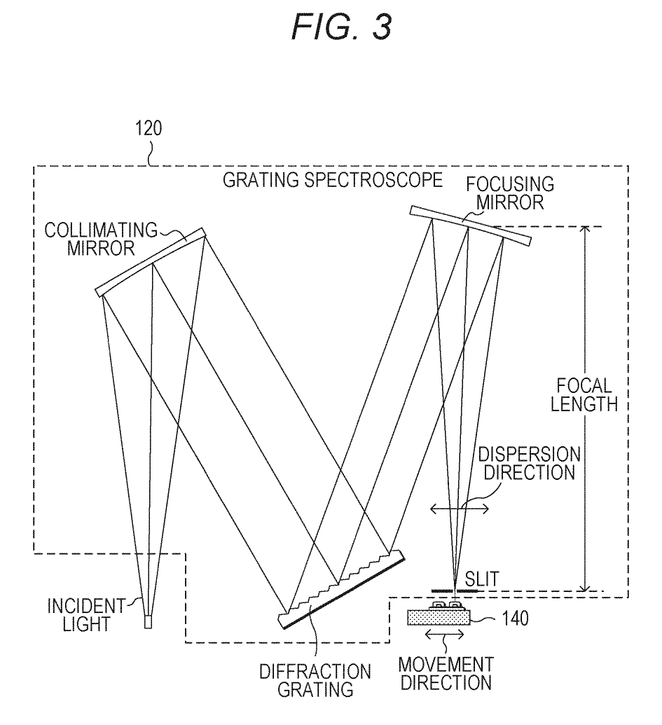

Here, the alignment direction of the photodiodes, that is, the movement direction of the parallel photodiodes 140 (the block 148) matches or substantially matches a dispersion direction (a dispersion direction of the grating spectroscope 120) of the emitted light from the grating spectroscope 120 (the optical bandpass filter 121) as illustrate in FIG. 3. That is, the driver 190 (and the controller 180) is configured to move the block 148 in the dispersion direction.

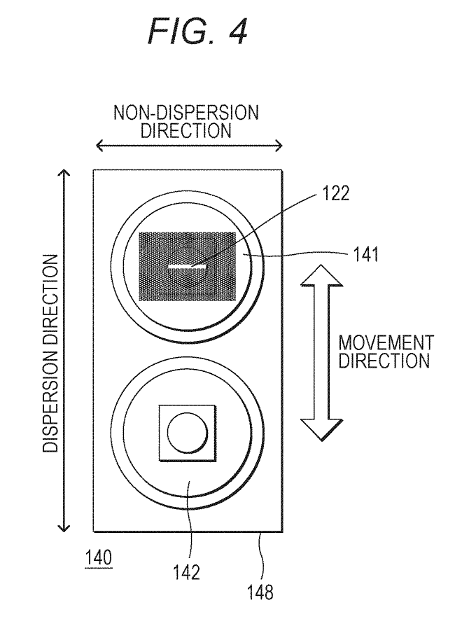

In the embodiment, the slit 122 is not a pinhole but has a horizontally long shape that extends in a non-dispersion direction (a non-dispersion direction of the grating spectroscope 120) of the emitted light from the grating spectroscope 120 as illustrated in FIG. 4. A thinness of the grating spectroscope 120 in the dispersion direction relates to a resolution and a sharpness of a measurement waveform. In view of this, the slit 122 is disposed such that a short side direction of the slit 122 aligns with the dispersion direction of the emitted light from the grating spectroscope 120. In contrast to this, a thinness of the grating spectroscope 120 in the non-dispersion direction has no substantial influence on the measurement waveform and the resolution. In view of this, expanding a width (a length) of the slit 122 in the non-dispersion direction ensures enhancing light receiving efficiency of the sensor (the photodiode sensor) of the first photodiode 141 and the sensor (the photodiode sensor) of the second photodiode 142.

However, it is difficult to dramatically lengthen the slit width in the non-dispersion direction. The reason is as follows. When the light is output from the slit 122, the light is formed into an image on the slit 122. The longer the slit 122 gets in the dispersion direction, the larger a size of an imaging beam gets. This is because the size of the imaging beam is susceptible to an aberration of a lens that plays a role to form the light into the image. Accordingly, the slit width in the non-dispersion direction is generally set to approximately 1 mm. This size is approximately as large as the photo-receiving surface of the photodiode.

Generally, the optical spectrum measurement device includes an alignment mechanism to automatically adjust a position of the photodiode to an optimal height. The driver 190 that moves the parallel photodiodes 140 may include this alignment mechanism.

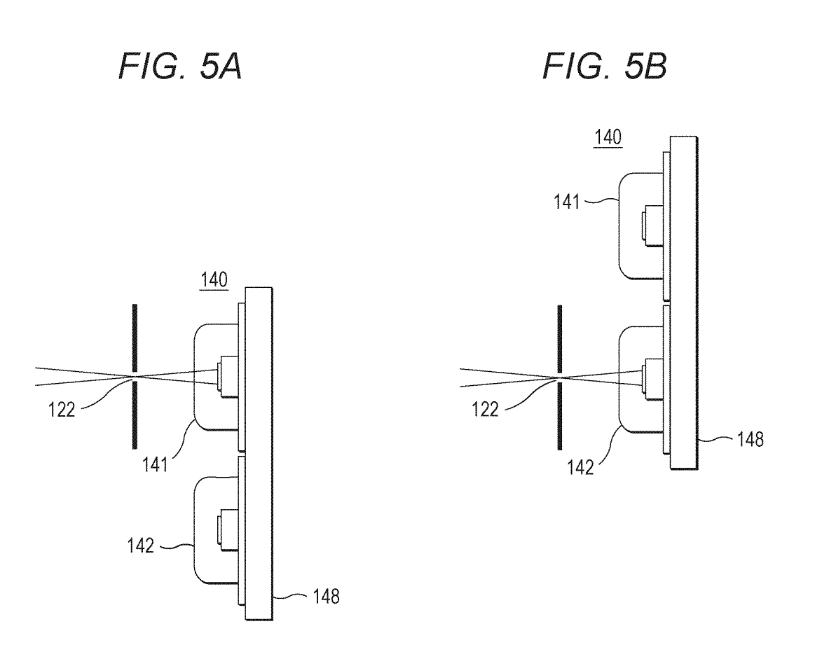

FIGS. 5A and 5B illustrate a state where the parallel photodiodes 140 move. FIG. 5A illustrates a state where the light that passes through the slit 122 enters into the first photodiode 141. FIG. 5B illustrates a state where the light that passes through the slit 122 enters into the second photodiode 142. The controller 180 switches these two states depending on the measurement bandwidth by controlling the driver 190. That is, the controller 180 sets a position of the parallel photodiodes 140 (the block 148) so as to achieve any of these two states by controlling the driver 190 depending on the measurement bandwidth.

As described above, in the embodiment, two photodiodes (the first photodiode 141 and the second photodiode 142) are aligned in the dispersion direction of the emitted light from the grating spectroscope 120. A shape of the sensor of the photodiode is generally a circular shape or a square shape. In the embodiment, as illustrated in FIG. 4, a shape of the light received on a sensor surface has a long shape in the non-dispersion direction of the emitted light from the grating spectroscope 120 by an influence of the slit 122. In view of this, a diameter of the emitted light from the slit 122 in the dispersion direction is smaller than a light receiving diameter of the sensor (there is a margin with respect to the light receiving diameter). This ensures restraining a variation of a light receiving level of the sensor caused by stationary position accuracy of the motor when the parallel photodiodes 140 move (when the photodiodes are switched). As a result, a stable measurement can be performed.

In contrast to this, aligning the photodiodes in the non-dispersion direction moves the photodiodes in a longitudinal direction of the slit 122. Then, a positional deviation of the photodiodes causes the light that passes through the slit 122 to easily miss the sensor of the photodiode. In view of this, a position sensitivity of the light receiving level of the photodiode becomes high, thereby making the stable measurement difficult.

It can be considered to increase a size of the sensor such that the light does not miss the sensor. However, as a property of the photodiode, increasing the size of the sensor generally increases a noise level. In view of this, the sensitivity of the photodiode as a measurement device decreases. In view of this, it is not preferred to easily increase the size of the sensor. Therefore, it is effective to align the first photodiode 141 and the second photodiode 142 in the dispersion direction of the emitted light from the grating spectroscope 120 as in the embodiment.

As illustrated in FIGS. 5A and 5B, in the optical spectrum measurement device 100 of the embodiment, the first photodiode 141 and the second photodiode 142 are disposed in parallel. This ensures the sensor of the first photodiode 141 and the sensor of the second photodiode 142 each independently receiving the light that passes through the slit 122. This ensures avoiding decreased measurement efficiency at the point where the sensitivities cross due to the light transmitting though the first sensor 581 and the influence of the ripple caused by the reflection between the end surfaces that occur when the coaxial composite photodiode 580 is used. In view of this, an optical spectrum measurement having a high resolution and accuracy in a wide wavelength range is ensured while the deterioration of the measurement quality is restrained.

In the coaxial composite photodiode 580 illustrated in FIG. 8, it is structurally difficult to dispose an independent cooling mechanism in the first sensor 581. Generally, the sensor of the photodiode can indicate the light sensitivity as quantum efficiency. This efficiency is temperature dependent. In view of this, the sensor is usually disposed on a cooling element to keep the temperature of the sensor constant. In the coaxial composite photodiode 580, it is difficult to independently dispose the cooling mechanism in the first sensor 581. In view of this, it is apprehended that a sensitivity property of the first sensor 581 changes depending on the temperature.

However, the parallel photodiodes 140 in the embodiment can dispose the first photodiode 141 and the second photodiode 142 on an individual or an identical cooling element. In view of this, a temperature rise of the sensors of the first photodiode 141 and the second photodiode 142 can be easily restrained. As a result, it is ensured restraining a change in the sensitivity property caused by a temperature change and avoiding an influence that the change in the sensitivity property has on the measurement waveform of the sensor.

As an example of a configuration of the parallel photodiodes 140, it is assumed that the first photodiode 141 includes the Si sensor and the second photodiode 142 includes the InGaAs sensor. This ensures securing a sensitivity in a wavelength range of 300 to 1800 nm. Combining these composite elements with the grating spectroscope 120 ensures achieving the optical spectrum measurement device 100 having a high resolution and a high sensitivity in a wide measurement bandwidth.

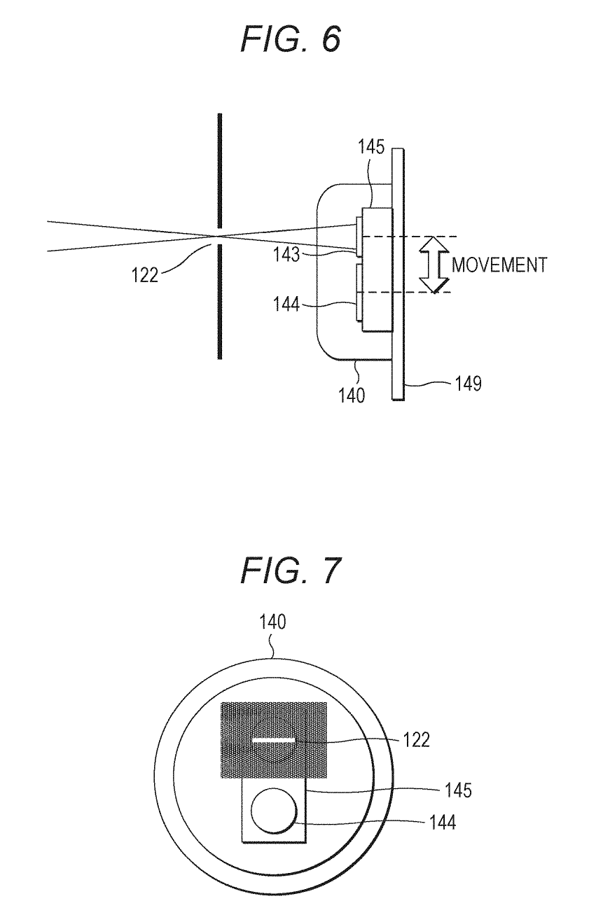

Next, a second example of the parallel photodiodes 140 will be described with reference to FIG. 6. In the first example of the parallel photodiodes 140, the plurality of sensors (the sensor of the first photodiode 141 and the sensor of the second photodiode 142) is housed in respective independent packages. In the second example, a plurality of different sensors (photodiode sensors) is aligned in one package. In the second example of the parallel photodiodes 140 illustrated in FIG. 6, a cooling element 145 is placed on a block 149. Furthermore, a first sensor 143 and a second sensor 144 are disposed on the cooling element 145 so as to align in the dispersion direction of the emitted light from the grating spectroscope 120.

Also in this case, the block (the movable table) 149 is moved by the driver 190. This causes the light that passes through the slit 122 to enter into any of the first sensor 143 and the second sensor 144. As illustrated in FIG. 7, the slit 122 is formed as a horizontally long slit that extends in the non-dispersion direction of the emitted light from the grating spectroscope 120. This ensures performing the measurement over a wide band with a high resolution and stability.

Furthermore, in the second example, a distance between the two sensors can be set significantly short. In view of this, a movement distance of the parallel photodiodes 140 becomes short, thereby ensuring further shortening a time that takes to switch the sensors. In the first example and the second example, the sensors employed as the parallel photodiodes 140 are generally the Si sensor and the InGaAs sensor. However, even the sensors having an identical material differ in a sensitivity wavelength range corresponding to a type. In view of this, selecting and combining an Si sensor type and an InGaAs sensor type as necessary ensures achieving a wide sensitivity wavelength range. As the sensor of the parallel photodiodes 140, a sensor having a different material from the Si and the InGaAs may be used.

At this time, depending on a combination of the sensors, there is a possibility of an existence of a wavelength range where the sensitivity decreases and there is a possibility of a large electrical noise of the sensor. In view of this, the selection of the sensors is preferred to be performed with care. However, appropriately combining the sensors has a possibility of achieving the measurement related to a wide band having a sensibility wavelength range of approximately 200 to 2500 nm. Thus, with the embodiment, it is ensured achieving the optical spectrum measurement device 100 that can execute the measurement over a wide band with a high resolution and a high sensitivity.

Note that the slit 122 may be included in the grating spectroscope 120. For example, the optical spectrum measurement device according to the one embodiment of this disclosure may include a grating spectroscope that includes an optical bandpass filter that disperses an incident light and a slit through which the dispersed light is emitted, a plurality of photodiode sensors that has mutually different light receiving properties, a movable table on which the plurality of photodiode sensors is placed so as to align on a planar surface perpendicular to a traveling direction of the emitted light from the slit, and a driving mechanism that moves the movable table so as to have a state where the emitted light enters into any of the plurality of photodiode sensors.

In this case, the slit may have a shape that extends in the non-dispersion direction of the emitted light from the optical bandpass filter. Furthermore, the plurality of photodiode sensors may be configured so as to align in the dispersion direction of the emitted light from the optical bandpass filter and such that the driving mechanism moves the movable table in the dispersion direction.

The optical spectrum measurement device according to the one embodiment of this disclosure may be the following first to fourth optical spectrum measurement devices.

The first optical spectrum measurement device includes a grating spectroscope that disperses an incident light and emits the incident light from a slit, a movable table on which a plurality of photodiode sensors having different light receiving properties is aligned on a planar surface perpendicular to a traveling direction of the emitted light from the slit, and a driving mechanism that moves the movable table into a state where the emitted light enters into any of the photodiode sensors.

In the second optical spectrum measurement device according to the first optical spectrum measurement device, the slit has a shape that extends in a non-dispersion direction of the incident light.

In the third optical spectrum measurement device according to the first or the second optical spectrum measurement device, the plurality of photodiode sensors is aligned in a dispersion direction of the incident light, and the driving mechanism moves the movable table in the dispersion direction of the incident light.

In the fourth optical spectrum measurement device according to any one of the first to the third optical spectrum measurement devices, the plurality of photodiode sensors is housed in one package.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An optical spectrum measurement device comprising:
a grating spectroscope that disperses an incident light, the grating spectroscope emitting the incident light from a slit;
a plurality of photodiode sensors that has mutually different light receiving properties;
a movable table on which the plurality of photodiode sensors is placed so as to align on a planar surface perpendicular to a traveling direction of an emitted light from the slit; and
a driving mechanism that moves the movable table so as to have a state where the emitted light enters into any of the plurality of photodiode sensors.

2. The optical spectrum measurement device according to claim 1, wherein
the slit has a shape that extends in a non-dispersion direction of an emitted light from the grating spectroscope.

3. The optical spectrum measurement device according to claim 1, wherein
the plurality of photodiode sensors is aligned in a dispersion direction of an emitted light from the grating spectroscope, and
the driving mechanism is configured to move the movable table in the dispersion direction.

4. The optical spectrum measurement device according to claim 2, wherein
the plurality of photodiode sensors is aligned in a dispersion direction of the emitted light from the grating spectroscope, and
the driving mechanism is configured to move the movable table in the dispersion direction.

5. The optical spectrum measurement device according to claim 1, wherein
the plurality of photodiode sensors is housed in one package.

6. The optical spectrum measurement device according to claim 2, wherein
the plurality of photodiode sensors is housed in one package.

7. The optical spectrum measurement device according to claim 3, wherein
the plurality of photodiode sensors is housed in one package.

8. The optical spectrum measurement device according to claim 4, wherein
the plurality of photodiode sensors is housed in one package.
